(19) United States
(12) Patent Application Publication
(10) Pub. No.: US 2026/0036205 A1
(43) Pub. Date: Feb. 5, 2026

(54) SEALING RINGS

(71) Applicant: John Crane Inc., Morton Grove, IL (US)

(72) Inventor: James R. Wasser, Chicago, IL (US)

(73) Assignee: John Crane Inc., Morton Grove, IL (US)

(21) Appl. No.: 19/252,753

(22) Filed: Jun. 27, 2025

Related U.S. Application Data
(60) Provisional application No. 63/677,551, filed on Jul. 31, 2024.

(51) Int. Cl. F16J 15/3284

(52) U.S. Cl. CPC F16J 15/3284

(57) ABSTRACT

One aspect of the invention provides an O-ring having a cross-section including projections on opposite sides of the O-ring such that pressure applied to the projections causes expansion of the O-ring in a direction orthogonal to the applied pressure. The O-ring includes: an elastomeric core; and a non-elastomeric coating on the elastomeric core. Another aspect of the invention provides a hollow O-ring having a hollow cross-section including: first and second rigid portions on opposite sides of the cross-section of the hollow O-ring; and first and second flexible portions connecting the first and second rigid portions to form the hollow O-ring. The hollow O-ring is configured to provide a seal between outward-facing surfaces of the first and second rigid portions of the O-ring and opposing external surfaces. The flexible portions are configured to flex to limit the pressure applied by the rigid portions to the opposing external surfaces.

### CROSS-REFERENCE TO RELATED APPLICATION(S)

This application claims the benefit of priority under 35 U.S.C. § 119(e) to U.S. Provisional Patent Application Ser. No. 63/677,551, filed Jul. 31, 2024. The entire content of this application is hereby incorporated by reference herein.

### FIELD OF THE INVENTION

The present invention relates to O-rings and in particular to O-rings comprising an elastomeric core coated with a non-elastomeric material, having a cross-section comprising projections configured to cause expansion of the O-ring under applied pressure. The present invention also relates to hollow O-rings comprising opposing rigid portions and flexible portions connecting the rigid portions, wherein the flexible portions are configured to limit the sealing pressure applied by the rigid portions.

### BACKGROUND

O-rings are a widely utilised type of seal or in the form of a toric ring, where the O-ring can be used to fill a space between surfaces to provide a seal, for example to provide a seal against leakage of a fluid. For example, an O-ring may typically be seated in a groove or recess of a surface and compressed against an opposing surface to form a seal between the surfaces.

O-rings may be used in various systems and may be used to provide static sealing or dynamic sealing (in which there is relative movement of a surface against the O-ring). Typically, O-rings are formed from elastomers such as rubber materials in order to provide for deformation of the ring under pressure to ensure an effective seal. Many applications for O-rings also require the O-ring material to have a level of chemical resistance in order to avoid chemical degradation of the seal. PFAS (per-fluoroalkyl substances) based materials, such as PFA (perfluoroalkoxy alkanes) or PTFE (polytetrafluoroethylene), may be used in seals to provide a combination of chemical resistance and desirable mechanical properties. However, concerns that PFAS materials may be potentially harmful to health and the environment make their use undesirable and potentially subject to regulations on their use. While non-PFAS based O-rings can provide suitable mechanical properties, rubbers are often susceptible to chemical degradation by swelling, loss of material and/or changes in mechanical properties. Alternative seals such as spring-loaded U-cups, which utilise a U-shaped plastic cross-section energised for expansion by a metallic spring, typically also rely on PFAS materials, and present serious practical challenges and increased costs that limit their effectiveness for use in mechanical seal applications, for example.

There is therefore a need for improved O-ring designs to address the above-mentioned challenges.

### SUMMARY

It has been surprisingly found that, by providing O-rings having a particular structure, beneficial mechanical properties may be obtained, whilst also allowing for chemically resistant materials to be used in place of solely rubber-based or PFAS containing materials.

A first aspect provides an O-ring having a cross-section comprising projections on opposite sides of the O-ring such that pressure applied to the projections causes expansion of the O-ring in a direction orthogonal to the applied pressure, wherein the O-ring comprises: an elastomeric core; and a non-elastomeric coating on the elastomeric core.

It will be appreciated that elastomeric materials, and particularly non-PFAS elastomers, are typically susceptible to chemical degradation. At the same time, many useful chemically resistant materials are non-elastomeric and, alone, are not suitable to provide the mechanical sealing properties desired of an O-ring. In addition, such non-elastomeric materials can typically be less susceptible to swelling from chemical absorption, but are often more susceptible to thermal expansion, which poses problems in systems where elevated temperatures are encountered.

It has been surprisingly found that, by provision of an O-ring having a structure in accordance with the first aspect, chemical resistance of the O-ring may be improved by the use of chemically resistant non-elastomeric materials, whilst maintaining mechanical benefits to sealing provided by the expansion of an elastomer under applied pressure. Without wishing to be bound by any particular theory, it is believed that a structure comprising projections to which pressure is applied can encourage orthogonal expansion of the elastomeric core, whilst also allowing for the non-elastomeric coating to more easily flex and account for the deformation of the elastomeric core. Where an O-ring having a non-elastomeric coating has a cross-section without projections, for example a circular cross section, it has been found that deformation of the O-ring under pressure can cause the coating to become bunched and crinkle on itself, causing excessive stress and bending of the coating which can cause damage.

As will be appreciated, O-rings are in general well known to the skilled person and the term O-ring as referred to herein will be understood to refer generally to a ring that is suitable for providing a seal when compressed between surfaces contacting the O-ring.

The cross section of an O-ring as referred to herein will be understood to refer to the generally rotationally symmetric cross-section of the O-ring, for example that defining a two-dimensional surface that can be rotated by 360° to define the toroidal shape of the O-ring. It will be appreciated that a toroid or toroidal shape as referred to herein refers to the shape of a ring, where the cross-section has a shape that need not be circular. For example, the O-ring may suitably have an axis of rotational symmetry extending through the centre of the central hole of the O-ring, and the cross-section referred to is that formed by a plane passing through and parallel to the axis of rotational symmetry. Similarly, the “axial direction” or “axially” as referred to herein will be understood to refer to the direction parallel to the axis of rotational symmetry of the O-ring, and the “radial direction” or “radially” as referred to herein will be understood to refer to the direction extending radially from and orthogonal to the axis of rotational symmetry.

As described, the cross-section of the O-ring comprises projections on opposite sides of the O-ring such that pressure applied to the projections causes expansion of the O-ring in a direction orthogonal to the applied pressure. It will be understood that the projections are not limited to any particular shape and the presence of the projections generally refers to a cross section in which the thickness of the O-ring in the direction comprising the projections is larger than the thickness of the O-ring in the direction orthogonal to the projections. The cross-section may have a generally circular or rounded shape that is elongated or stretched along one axis. For example, the O-ring may have an oval or elliptical cross-section where the projections refer to the projection of the ends of the oval or ellipse along its major (longest) axis. In this way, the cross-section may comprise a continuous curved outline. In some preferred embodiments, the projections may comprise irregular projections outward from a continuous shape of the cross-section. For example, the cross-section may have a generally rounded shape, such as generally circular, oval or elliptical, with projections extending outwards beyond the outline of the regular shape forming a central portion of the cross-section.

In some preferred embodiments, the O-ring may comprise a flat surface at the extent of each projection (or only one of the projections) configured to abut a surface against which the O-ring can form a seal. For example, the cross section may comprise a generally rounded shape such as a circular, oval or elliptical shape, wherein the projections comprise generally square or rectangular protrusions extending from opposing sides of the cross-section. As will be appreciated, while generally square or rectangular shapes are mentioned, projections of any suitable shape may extend from opposing sides of the cross-section of the O-ring.

As will be appreciated, the projections provide for concentration of applied pressure pushing into the core of the O-ring, which causes expansion of the O-ring orthogonally to the applied pressure on the projections. Without wishing to be bound by any particular theory, it is believed that the projections providing for deformation of the O-ring in the direction containing the projections can advantageously enable flexing of the non-elastomeric coating to aid expansion of the O-ring orthogonal to the applied pressure. In this way, a non-elastomeric coating having superior chemical resistance to the elastomeric core can be used to increase resistance, whilst improving flexing of the non-elastomeric material to avoid losing the beneficial sealing properties provided by an elastomer. The use of a coating of a non-elastomeric material, rather than as a bulk material in the O-ring, can also avoid potential issues of thermal expansion of the non-elastomeric material, which when in a pressurised system could cause rupture of the O-ring and/or components in direct or indirect contact with the O-ring.

In some instances, the thickness of the coating may be varied in order to aid flexing of the coating and expansion of the O-ring orthogonally to the applied pressure. For example, the non-elastomeric coating may be thicker at the projections where pressure is applied than it is at the sides orthogonal to the projections, which may aid expansion of the O-ring in the direction orthogonal to the projections under applied pressure.

The cross-section of the O-ring may suitably have 2-fold or 180° symmetry, for example wherein the projections are the same on both sides of the O-ring, and/or the cross-section may have a mirror or reflectional line of symmetry through the centre of the O-ring, for example a line of symmetry bisecting the projections and/or passing through both projections. Nonetheless, in some instances, the projections at either side of the cross-section may be different and the cross-section may in some instances have no rotational and/or no mirror symmetry.

The orientation of the projections relative to the overall shape of the O-ring may be determined based on the desired use and the anticipated directions of pressure to which the O-ring will be subject. Preferably, relative to a rotational axis of symmetry of the O-ring, the projections extend in the axial direction so that pressure applied to the projections causes expansion of the O-ring in the radial direction, or, alternatively, the projections may extend in the radial direction and pressure applied to the projections causes expansion of the O-ring in the axial direction.

The non-elastomeric coating may be any suitable material, but preferably comprises a plastic. The non-elastomeric coating is preferably formed from a material having superior chemical resistance to the material forming the elastomeric core. For example, ISO 175:2010 defines test methods for measuring the effects of chemicals on plastics that can be used to determine chemical resistance in relation to changes in mass, dimensions (e.g. swelling), or changes in other physical properties. In particular, the non-elastomeric core is preferably more resistant than the elastomeric core in respect of water, organic solvents or compounds such as hydrocarbon liquids and gases or oils. In some preferred embodiments, the non-elastomeric coating is formed from a material having a water absorption, as measured in accordance with ISO 62:2008, of less than 0.5%, preferably less than 0.2% for example less than 0.1%, when immersed in water at 23° C. for 24 hours. The non-elastomeric coating preferably comprises a polymer such as ABS (acrylonitrile butadiene styrene), a polyether or a polyamide, preferably a polyaryletherketone such as PEEK (polyetheretherketone). In preferred embodiments the non-elastomeric coating comprises or consists essentially of PEEK. Such polymers can typically demonstrate good chemical resistance, but poor elasticity. An O-ring as described herein having a coating of such materials over an elastomeric core allows the benefits of chemical resistance without losing the beneficial sealing properties of an elastomer. In some instances, the material from which the non-elastomeric coating is formed may be susceptible to thermal expansion, and the provision of the material as only a coating can mitigate problems caused by thermal expansion. For example, the material from which the non-elastomeric coating is formed may have a coefficient of linear thermal expansion (as, for example, measured by ISO 11359-2:2021) of greater than 20×10⁻⁶ K⁻¹, for example greater than 30×10⁻⁶ K⁻¹, such as at least 45×10⁻⁶ K⁻¹. The tensile modulus of elasticity of the material forming the non-elastomeric coating may for example be greater than 2 GPa, for example greater than 3 GPa, such as at least 4 GPa (as, for example, measured by ISO 527-1:2019).

As will be appreciated, O-rings are typically formed from elastomeric materials, and any suitable elastomer may be used for the elastomeric core. Preferably, the elastomeric core comprises a rubber, for example a synthetic rubber such as nitrile rubber, an olefin thermoplastic rubber such as EPDM (ethylene propylene diene monomer) rubber, ethylene propylene rubber, styrene butadiene rubber, butadiene rubber, neoprene rubber, silicone rubber or polyurethane rubber. It will be appreciated that an elastomeric core may generally be formed by any suitable method and elastomeric O-rings are well known in the art. The elastomeric core may, by way of example, be formed by extrusion, injection molding, pressure molding or transfer molding.

The O-ring preferably comprises less than 1 wt. % PFAS materials, for example less than 0.5 wt. % PFAS materials, such as less than 0.1 wt. % PFAS materials. In preferred embodiments, the O-ring is PFAS-free. It is a particular advantage of the coated O-ring design that chemically resistant and non-elastomeric materials can be used as a coating whilst also providing the beneficial sealing properties of the elastomeric core, which enables non-PFAS materials to be used for both the elastomer and the coating.

The thickness of the coating on the elastomeric core may be any suitable thickness, and it will be appreciated that the thickness of the coating may vary depending on the overall size of the O-ring and the elastomeric core, and the exact materials used. In preferred embodiments, the coating has a thickness of no more than 1000 μm, preferably no more than 500 μm, for example no more than 300 μam. It will also be appreciated that the coating may be applied in a uniform thickness, or the thickness may be varied, for example in order to aid flexing of selected portions of the coating. For example, in some preferred embodiments, the coating has a lower thickness at at least one surface of the O-ring orthogonal to those comprising the protrusions, to facilitate the expansion of the O-ring.

The non-elastomeric coating may be applied to the elastomeric core in any suitable way. For example, the coating may, by way of example, be applied by 3D printing, dip coating or spray coating. In preferred embodiments, the coating is applied by 3D printing. 3D printing may be used to form the coating over a pre-made elastomeric core, or where the elastomer is compatible, the elastomeric core and the coating may be simultaneously 3D printed by a multi material 3D printing process.

As discussed, one possible problem with the use of chemically resistant materials in O-rings, where PFAS materials are avoided, is that suitably chemically resistant materials are typically non-elastomeric materials. Such materials can also often be susceptible to thermal expansion to a greater extent than conventional rubbers that are typically used in O-rings. When used in a pressurised system, O-rings formed from materials susceptible to thermal expansion can cause rupture of the O-ring and/or components in direct or indirect contact with the O-ring. For example, one use of O-rings is in rotating mechanical seals such as may be used to seal around a rotating shaft. Such seal systems typically comprise a static sealing ring and a rotating sealing ring that form a seal at their interface, and these components are often used in combination with O-rings to provide secondary seals around these static or rotating sealing rings. Where an O-ring suffers from excessive thermal expansion, this can distort or crack the static and rotating sealing rings, leading to failure of the seal.

A second aspect provides a hollow O-ring having a hollow cross-section comprising: first and second rigid portions on opposite sides of the cross-section of the hollow O-ring; and first and second flexible portions connecting the first and second rigid portions to form the hollow O-ring; wherein the hollow O-ring is configured to provide a seal between outward-facing surfaces of the first and second rigid portions of the O-ring and opposing external surfaces, and the flexible portions are configured to flex to limit the pressure applied by the rigid portions to the opposing external surfaces.

By providing a hollow O-ring configured in this way, it can advantageously be possible to avoid the use of elastomers that are susceptible to chemical degradation, whilst also mitigating potential damage from thermal expansion. For example, the rigid portions of the O-ring can form a seal between opposing external surfaces, and, even in the case that thermal expansion occurs, the flexible portions of the O-ring can flex to “take up” the additional pressure without imparting excessive pressure to the external surfaces with which the O-ring is in contact.

The O-ring is a hollow O-ring, which will be understood to mean that the O-ring has a generally toroidal shape in which the cross-section of the toroid is hollow. It will be appreciated that reference to the cross-section of the O-ring refers to the generally rotationally symmetric cross-section of the O-ring as defined in relation to the first aspect.

The hollow O-ring is preferably formed from a non-elastomeric material, preferably a plastic. The hollow O-ring may be formed from a non-elastomeric material as defined previously in relation to the first aspect. The O-ring may for example be formed from ABS (acrylonitrile butadiene styrene), a polyether or a polyamide, preferably a polyaryletherketone such as PEEK. The O-ring preferably comprises less than 1 wt. % PFAS materials, for example less than 0.5 wt. % PFAS materials, such as less than 0.1 wt. % PFAS materials. In preferred embodiments, the O-ring is PFAS-free. It is a particular advantage of the hollow O-ring design that chemically resistant and non-elastomeric materials can be used, without the need for PFAS materials to provide chemical resistance.

The hollow O-ring preferably comprises a single continuous material that forms the ring, though it will be appreciated that other materials such as coatings may also be present in some instances. The hollow O-ring may be formed by any suitable method, though it is particularly preferred that the O-ring is formed by 3D printing. 3D printing offers an advantageous way to form the hollow structure of the O-ring whilst also permitting straightforward formation of the rigid and flexible portions in the same O-ring.

The first and second flexible portions may be in any suitable form that allows for flexing of the flexible portion to limit the pressure that can be applied by the rigid portions on expansion of the O-ring material. The shape of the material forming the flexible portions may suitably be adapted to provide flexibility. The first and/or second flexible portions preferably comprise corrugations in the surface of the O-ring, for example the first and second flexible portions may have a cross-section comprising a series of alternating ridges and depressions (for example following a curved or wavy path in the general manner of a sine wave or a path following a series of angled straight lines forming a triangle or sawtooth wave). The corrugated profile of the flexible portions can allow stretching and compression of the flexible portions to account for forces applied to the rigid portions. Due to the shape of the flexible portions, the material that forms the O-ring may be non-elastomeric, as the flexibility can result from the shape rather than directly from the properties of the material itself (as it would in the case of a conventional non-hollow elastomeric O-ring). It will nonetheless be appreciated that any suitable profile for the flexible portions may be used that permits compression between the rigid portions. As the rigid portions that are connected by the flexible portions are on opposite sides of the O-ring, the flexible portions can act as a spring extending between the rigid portions.

The first and second rigid portions of the O-ring will be understood to be rigid in the sense that the shape of the material forming the rigid portions is not adapted to allow flexing. It will nonetheless be appreciated that the relative rigidity of the rigid portions will depend on the material they are formed from. The first and/or second rigid portions preferably comprise a flat annular external surface of the O-ring for sealing against an opposing external surface. For example, each rigid portion may comprise a continuous block of material forming a flat outward facing surface on the O-ring. The inner surface of the rigid portion (that is, the surface facing into the hollow interior of the O-ring) may be flat, for example so as to provide a substantially rectangular cross-section for the rigid portion, but it will be appreciated that the inner surface need not be flat. The flexible portions may extend from the rigid portion at opposite ends of the inner surface of the rigid portions, though it will be appreciated that in some instances the ends of the rigid portions may extend past the point at which the flexible portions join the rigid portions, so that the flexible portions join the rigid portions at the inner surface of the rigid portions.

It will be appreciated that the general shape of the cross-section of the hollow O ring is that of having two opposite generally flat ends approximately parallel with each other, connected by two flexible portions to form a hollow toroid. For example, the hollow O-ring may generally be in the form of a square or rectangular toroid, wherein the sides formed by the flexible portions may nonetheless comprise variations from a flat profile such as corrugations.

The thickness of the rigid and flexible portions of the O-ring may suitably be varied depending on the dimensions of the O-ring as a whole. The thickness of the flexible portions may be different to that of the rigid portions, for example the thickness of the flexible portions is preferably lower than the thickness of the rigid portions, which may aid flexing of the flexible portions. Thus, the hollow O-ring preferably has a lower thickness at the first and second flexible portions than at the first and second rigid portions to facilitate flexing.

An O-ring according to either of the first or second aspects is preferably an O-ring for providing a seal in a mechanical seal system, for example wherein the mechanical seal is arranged to provide a seal around a rotating shaft. For example, a mechanical seal may seal around the circumference of a rotating shaft of a compressor or similar rotating machine. It will nonetheless be appreciated that the O-rings described herein may be used in other contexts in any suitable system to provide a seal.

As the O-rings described herein allow for the use of non-elastomeric materials to be used at the sealing surface of the ring, materials providing low friction when sliding against other surfaces may advantageously be used. For example, the O-ring may be suitable as a dynamic O-ring seal in which the O-ring forms a seal against a surface that moves axially relative to the O-ring. By way of example, plastic such as PEEK may be used in the formation of the coating or the hollow O-ring, which provides a durable and low friction surface in addition to providing chemical resistance.

Thus, a further aspect provides a mechanical seal system comprising an O-ring (e.g. one or more O-rings) as defined elsewhere herein in relation to the first or second aspect. The mechanical seal preferably can be arranged to provide a seal around a rotating shaft.

The mechanical seal may suitably comprise a static sealing ring and a rotating sealing ring that form a seal at their interface. An O-ring as described herein may preferably be arranged to provide a secondary seal around the static and/or rotating sealing rings in the mechanical seal. For example, the mechanical seal system may be configured to provide a seal between respective sealing surfaces of a rotating “primary” ring and a stationary “secondary” ring, wherein the O-ring is arranged to provide a seal against a surface of the primary ring and/or the secondary ring other than the sealing surface at the interface between the primary and secondary rings. Where an O-ring suffers from excessive thermal expansion in such an arrangement, this can distort or crack the static or rotating sealing rings, leading to failure of the seal. By the use of only a coating of non-elastomeric material on the O-ring or by the use of a hollow O-ring as described herein, chemically resistant but thermally expanding materials may be used whilst mitigating the risk of damage from thermal expansion of the O-ring in use. It will be appreciated that the O-rings may also be used in other parts of a mechanical seal, for example to form a seal between housing components or to seal a sleeve to the rotating shaft, where the sleeve carries the rotating or primary sealing ring.

Where an O-ring according to the first aspect is used, this may suitably be configured to provide a seal against at least three surfaces, such as three or four surfaces, within the mechanical seal. It will be appreciated that the O-ring according to the second aspect may be configured to seal against two opposing surfaces in the mechanical seal. Relative to the axis of rotation of the rotating shaft of the mechanical seal, the O-rings may suitably seal between or against surfaces in the axial direction, and/or between or against surfaces in the radial direction.

A further aspect provides a method for forming an O-ring, comprising 3D printing a non-elastomeric plastic as a coating on an elastomeric ring, or 3D printing to form a hollow ring formed from the non-elastomeric plastic. 3D printing offers an advantageous way to form the O-rings described previously herein. For example, by the use of 3D printing, the non-elastomeric coating may be applied to the elastomeric core with advantageous control over the thickness of the coating. For example, by 3D printing it may be possible to easily vary the thickness of the coating to provide thinner portions of the coating that encourage expansion of the O-ring when pressure is applied to the O-ring as described previously herein. Similarly, 3D printing provides an advantageous way to form the hollow structure of the O-ring whilst also permitting straightforward formation of the rigid and flexible portions in the same O-ring, where thickness of the material forming the hollow O-ring may be easily varied, for example to control the flexibility of flexible portions as described previously herein. As will be appreciated, the method preferably comprises 3D printing to form a coated O-ring as defined elsewhere herein or 3D printing to form a hollow O-ring as defined elsewhere herein.

### BRIEF DESCRIPTION OF FIGURES

Embodiments of the disclosure will now be described, by way of example only, with reference to the accompanying drawings, in which:

FIG. 1 shows a cross-section of a coated O-ring comprising projections in accordance with the first aspect;

FIG. 2 shows a cross-section of a hollow O-ring in accordance with the second aspect;

FIG. 3 shows a cross section of an example mechanical seal system comprising O rings.

### DETAILED DESCRIPTION

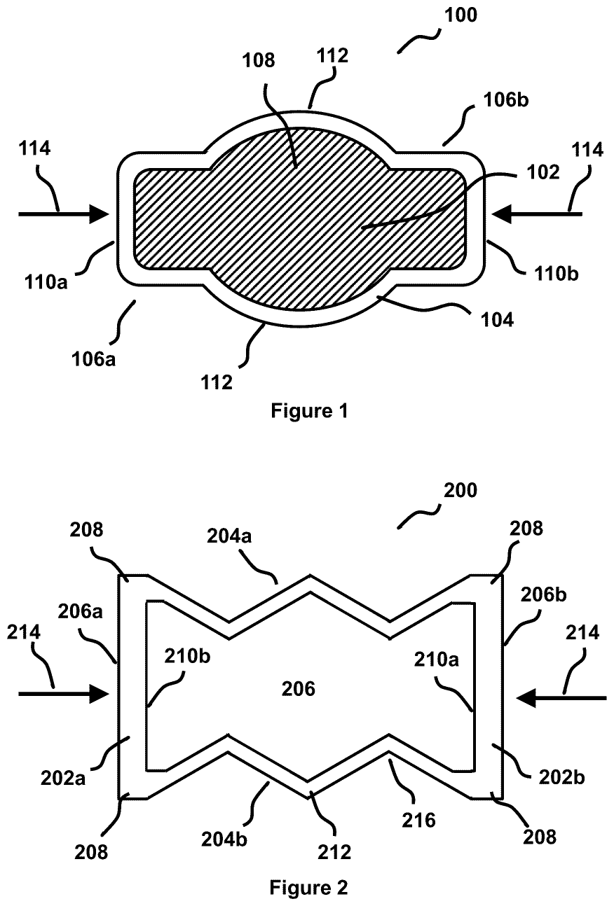

FIG. 1 shows a view of the cross-section of a coated O-ring comprising projections in accordance with the present disclosure. With reference to FIG. 1, an O-ring 100 is shown as a cross-sectional view of the rotationally symmetric cross-section of the O-ring 100 (i.e. a cross-section obtained by cutting the O-ring in a plane extending radially outwards from the central hole of the ring, parallel to the axis of rotational symmetry).

The O-ring 100 has an elastomeric core 102, which may be made from any suitable elastomer such as a synthetic rubber, and a non-elastomeric coating 104, preferably made from a non-elastomeric but chemically resistant plastic such as PEEK. The cross-section comprises two projections 106a, 106b, that extend outwards in opposite directions from a central portion 108 of the cross-section. The projections 106a/106b each comprise an outward facing flat surface 110a/110b at the extent of each projection. The flat surfaces 110a/110b can abut against opposing external surfaces to form a seal between the flat surfaces 110a/110b and the external surfaces. In FIG. 1, the central portion 108 is shown as having a rounded profile in the form of an oval or ellipse having curved upper and lower surfaces 112, where substantially rectangular projections 106a/106b extend from the sides of the central portion 108. It will nonetheless be appreciated that other shapes are possible, for example the projections 106a/106b may be rounded rather than generally rectangular in form.

Under applied pressure as shown by arrows 114, the projections 106a/106b compress inwards into the central portion 108, causing expansion of the central portion at the upper and lower curved surfaces 112. The coating 104 at the upper and lower surfaces 112 may in some instances be thinner than the coating at the flat surfaces 110a/110b, in order to aid expansion of the central portion 108 under applied pressure 114. Under pressure 114, the O-ring 100 may suitably form a seal between the flat surfaces 110a/110b and at one or both of the curved surfaces 112, wherein the expansion under pressure aided by the projections 106a/106b provides pressure to seal one or both of the curved surfaces 112 against an external surface. For example, the O-ring 100 may be places in a groove on a surface of a first element (for example of a mechanical seal), wherein compression by the sides of the groove along lines 114 causes expansion of the O-ring 100 out from the groove to seal against a surface of a second element (for example of the mechanical seal).

While the coating 104 is made from a non-elastomeric material, the elongate shape in the direction of the projections 106a/106b of the cross-section of O-ring 100 can provide for improved expansion of the coated O-ring 100 at the central portion 108 when the O-ring 100 is compressed. For example, due to the elongation provided by the projections 106a/106b, minor flexing of the coating 104 can allow for expansion without significantly stretching or distorting the coating 104, which could lead to rupture. In this way, the coating 104 can provide a chemically resistant barrier to the elastomeric core 102, whilst maintaining beneficial sealing properties obtained by distortion of the O-ring under pressure.

FIG. 2 shows a cross-section of a hollow O-ring comprising rigid and flexible portions in accordance with the present disclosure. With reference to FIG. 2, an O-ring 200 is shown as a cross-sectional view of the rotationally symmetric cross-section of the O-ring 200 (i.e. a cross-section obtained by cutting the O-ring in a plane extending radially outwards from the central hole of the ring, parallel to the axis of rotational symmetry).

The O-ring 200 comprises a shell formed from rigid portions 202a/202b and flexible portions 204a/204b connecting the rigid portions to form a hollow toroidal ring having a void 206 in its centre. The rigid portions 202a/202b comprise outward facing and parallel flat surfaces 206a/206b configured to abut against and provide a sealing surface against opposing external surfaces. Although a flat outward facing surface 206a/206b is shown in FIG. 2, in some instances this surface may be curved or otherwise distorted from flat. Similarly, while the inward facing surface 210a/210b of the rigid portions 202a/202b is shown as flat in FIG. 2, these surfaces need not be flat and may, for example be curved or follow any other non-flat profile. It will be appreciated that the orientation of the cross-section shown in FIG. 2 (as well as the cross-section shown in FIG. 1) is not limited, and the rigid portions 202a/202b and surfaces 206a/206b may contact external surfaces in the axial or the radial direction.

The flexible portions 204a/204b extend between the ends 208 of the rigid portions to form a closed hollow cross-section around the void 206. It will be appreciated that the flexible portions 204a/204b may in some instances extend from the inward facing surface 210a/210b at a point shifted inwards from the end 208 of the rigid portions 202a/202b such that the end 208 overhangs the join of the rigid and flexible portions.

The flexible portions 204a/204b have a corrugated profile comprising a series of ridges 212 and depressions 216 to provide a profile in the form of a triangular wave. It will nonetheless be appreciated that other arrangements are possible. For example, while the profile of the flexible portions 204 in FIG. 2 are shown as straight sections forming a triangular arrangement, the flexible portions 204 may have curved profile, for example in the manner of a regular or distorted sine wave. The arrangement of the straight sections of the flexible portions 204 in FIG. 2 may also in some instances not follow a symmetrical triangular profile, but an asymmetric path such as that of a sawtooth wave. The corrugated profile of the flexible portions 204 can allow for compression of the flexible portions under applied pressure 214. The relative size of the ridges 212 and depressions 216 shown in FIG. 2 is only schematic, and may suitably be varied, for example to vary the height of the ridges 212 and depressions 216 or to vary the number of ridges 212 and depressions 216 present in each flexible portion 204 between the rigid portions 202.

While the inherent rigidity of the material forming the O-ring 200 provides resistance to compression, the presence of the flexible portions 204 provides a limit on the force that can be applied by the O-ring 200 in opposition to the compression force 214 (i.e. the force between the external surfaces against which the O-ring seals), because as the forces increase the flexible portion can further flex and compress to relieve pressure. This is particularly beneficial where the O-ring 200 is formed from a material that is susceptible to thermal expansion, because if the O-ring 200 expands under pressure in a system where it is already under compression to provide sealing, the additional expansion could cause distortion or breakage of components against which the O-ring 200 seals. The flexible portions 204 can at least partially relieve excess pressure caused by thermal expansion so reduce the risk of damage due to excessive expansion of the O-ring.

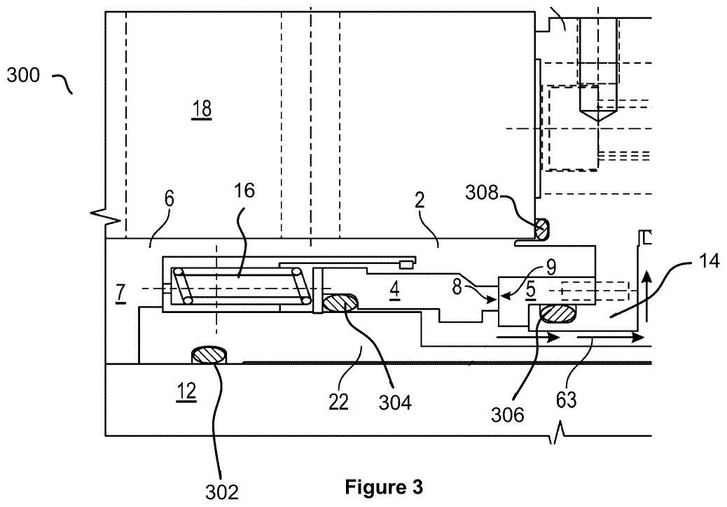

FIG. 3 shows an example, in cross-section, of a mechanical seal system 300 containing O-rings 302, 304, 306, 308, wherein the seal system 300 is configured to provide a seal around a rotating shaft 12 in a bore 6 formed in a machine to seal a chamber 7 inside the machine. As will be appreciated, a cross-section of only one side of the mechanical seal system 300 is shown and the seal surrounds the rotating shaft 12 to form a seal around the circumference of the shaft 12. An annular housing 18 of the machine is shown in FIG. 3, though it will be appreciated that the O-rings described herein may be used in any suitable system. By way of example, the seal system 300 shown seals a liquid in a chamber 7, such as pumping or process gas chamber, for example the chamber 7 may include a light end such as liquified petroleum gases (however this is merely an illustrative example). The mechanical seal system 300 can provide a seal for the chamber 7, for example, with respect to the ambient surroundings of the machine.

In FIG. 3, a seal 2 includes a primary ring 4 and a secondary ring 5 having respective opposing faces 8 and 9 that rotate relative to one another in operation and a seal is formed between faces 8 and 9. In this example, a small amount of liquid from chamber 7 may lubricate the faces 8, 9 of the sealing rings 4, 5 and in operation a small amount may pass through the seal and escape, for example as a gas, along pathway 63. Nonetheless, it will be appreciated that the O-rings described herein may be used in any suitable system, and the mechanical seal may for example comprise a dry gas seal or any other suitable mechanical seal system.

An annular sleeve 22 is fixedly attached to the shaft 12 and rotates with the shaft. An O-ring 302 is used to provide a seal between the sleeve 22 and the shaft 12, to prevent leakage between the sleeve 22 and the shaft 12. In the example shown in FIG. 3, the primary ring 4 is carried on the annular sleeve 22 and an O-ring 304 is used to provide a seal between the primary ring 4 and the annular sleeve 22. In the example shown, a biasing mechanism 16 urges the primary ring 4 towards the secondary ring 5 to form a seal between the faces 8 and 9 and so the O-ring 304 between the primary ring 4 and the annular sleeve 22 may provide a dynamic seal as the primary ring 4 moves axially inboard (towards chamber 7) or outboard (away from chamber 7). This is merely an example and in other examples the secondary ring 5 could instead be configured with a biasing mechanism to urge the secondary ring 5 towards the primary ring 4. As shown in FIG. 3, the secondary ring 5 is carried by a carrier ring 14 and is sealed against the carrier ring 14 by an O-ring 306 to prevent leakage around the seal interface provided between faces 8 and 9. The carrier ring 14 can be fixedly attached to the annular housing 18 and sealed with a further O-ring 308.

While FIG. 3 shows O-rings in the context of a specific mechanical seal system, it will be appreciated that this is merely an example and uses of O-rings in other mechanical seal systems and uses not relating to mechanical seals would be apparent to the skilled person.

1. An O-ring having a cross-section comprising projections on opposite sides of the O-ring such that pressure applied to the projections causes expansion of the O-ring in a direction orthogonal to the applied pressure, wherein the O-ring comprises:
an elastomeric core; and
a non-elastomeric coating on the elastomeric core.

2. An O-ring according to claim 1, wherein the non-elastomeric coating comprises a plastic.

3. An O-ring according to claim 2, wherein the plastic is selected from the group consisting of: ABS, a polyether, a polyamide, a polyaryletherketone, and PEEK.

4. An O-ring according to claim 1, wherein the elastomeric core comprises a rubber.

5. An O-ring according to claim 4, wherein the rubber is selected from the group consisting of: a synthetic rubber, nitrile rubber, an olefin thermoplastic rubber, EPDM rubber, ethylene propylene rubber, styrene butadiene rubber, butadiene rubber, neoprene rubber, silicone rubber, and polyurethane rubber.

6. An O-ring according to claim 1, wherein the coating has a thickness of no more than 1000 μam.

7. An O-ring according to claim 1, wherein the coating has a thickness of no more than 500 μam.

8. An O-ring according to claim 1, wherein the coating has a thickness of no more than 300 μam.

9. An O-ring according to claim 1, wherein, relative to a rotational axis of symmetry of the O-ring, the projections extend axially and pressure applied to the projections causes expansion of the O-ring radially, or wherein the projections extend radially and pressure applied to the projections causes expansion of the O-ring axially.

10. An O-ring according to claim 1, wherein the non-elastomeric coating is 3D printed onto the elastomeric core.

11. An O-ring according to claim 1, wherein the coating has a lower thickness on at least one surface of the O-ring orthogonal to those comprising the projections, to facilitate the expansion of the O-ring.

12. An O-ring according to claim 1, wherein the O-ring is an O-ring for providing a seal in a mechanical seal system.

13. An O-ring according to claim 12, wherein the mechanical seal is arranged to provide a seal around a rotating shaft.

14. An O-ring according to claim 1, wherein the O-ring is PFAS-free.

15. A mechanical seal system comprising an O-ring according to claim 1.

16. A hollow O-ring having a hollow cross-section comprising:
first and second rigid portions on opposite sides of the cross-section of the hollow O-ring; and
first and second flexible portions connecting the first and second rigid portions to form the hollow O-ring;
wherein the hollow O-ring is configured to provide a seal between outward-facing surfaces of the first and second rigid portions of the O-ring and opposing external surfaces, and the flexible portions are configured to flex to limit the pressure applied by the rigid portions to the opposing external surfaces.

17. An O-ring according to claim 16, wherein the O-ring is PFAS-free.

18. An O-ring according to claim 16, wherein the O-ring is formed by 3D printing.

19. A mechanical seal system comprising an O-ring according to claim 16.

20. A method for forming an O-ring, comprising 3D printing a non-elastomeric plastic as a coating on an elastomeric ring, or 3D printing to form a hollow ring formed from the non-elastomeric plastic.
